(19) United States
(12) Patent Application Publication
(10) Pub. No.: US 2014/0168101 A1
(43) Pub. Date: Jun. 19, 2014

(54) APPARATUS AND METHOD CAPABLE OF ERASING CONTENT DISPLAYED ON TOUCH SCREEN

(71) Applicants: WEI-GUO XIAO, Shenzhen (CN); YI-YING CHEN, New Taipei (TW); CHIU-HSIUNG LIN, New Taipei (TW)

(72) Inventors: WEI-GUO XIAO, Shenzhen (CN); YI-YING CHEN, New Taipei (TW); CHIU-HSIUNG LIN, New Taipei (TW)

(21) Appl. No.: 13/727,488

(22) Filed: Dec. 26, 2012

(30) Foreign Application Priority Data
Dec. 13, 2012 (CN) 201210537613.X

(51) Int. Cl. G06F 3/041

(52) U.S. Cl. CPC G06F 3/0414
USPC 345/173

(57) ABSTRACT

An apparatus capable of erasing content includes a touch display unit, a time calculating time, a storage unit, an area detecting unit, a control unit, and an erasing unit. The touch display unit determines a first touched place of a touch operation applied by an input apparatus on the touch display unit, a touch area of the first touched place, and a touch trace of the touch operation according to changing of touch coordinates. The control unit activates the time calculating unit to calculate a time duration of the touch operation when the size of the touch area is larger than the predetermined area size, and generates an erasing signal when the touch trace matches a predetermined trace pattern. The erasing unit erases content covered by the touch trace on the touch display unit in response to the erasing signal. A related method is also provided.

### BACKGROUND

1. Technical Field

The present disclosure relates to touch input technology and, particularly, to an apparatus and a method that can erase content displayed on a touch screen.

2. Description of the Related Art

Many electronic devices employ touch screens to display content input by an input apparatus. On screen content can be erased by an erasing program, which may involve erasing all visible content or just some content depending on user input. However, operations required of a user to selectively erase content can be troublesome and time consuming. Therefore, there is room for improvement within the art.

### BRIEF DESCRIPTION OF THE DRAWING

The components in the drawings are not necessarily drawn to scale, the emphasis instead being placed upon clearly illustrating the principles of the disclosure. Moreover, in the drawing, like reference numerals designate corresponding parts throughout the several views.

FIG. 1 is a block diagram of an apparatus capable of erasing content displayed on a touch screen, according to an exemplary embodiment.

FIG. 2 is a schematic diagram showing a state of use of erasing content displayed on the touch screen of the apparatus of FIG. 1, in accordance with an exemplary embodiment.

FIG. 3 is a flowchart of a method capable of erasing content displayed on a touch screen in accordance with an exemplary embodiment.

### DETAILED DESCRIPTION

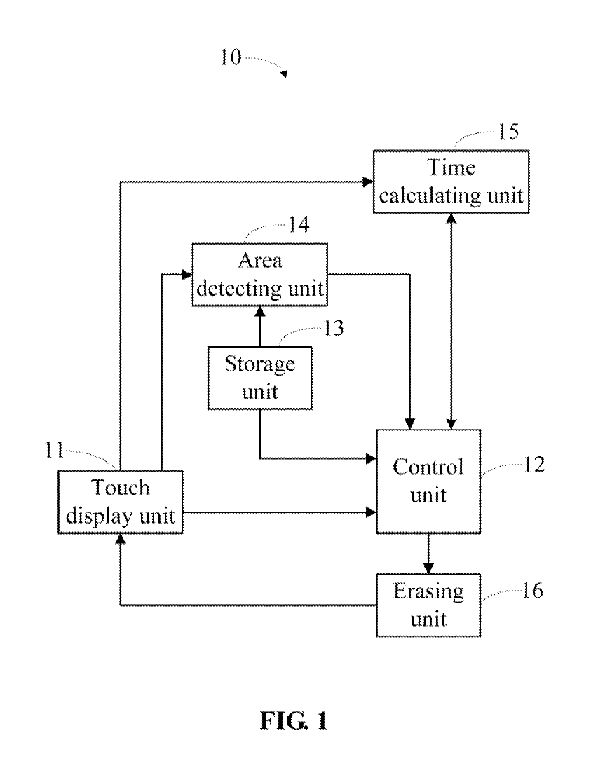

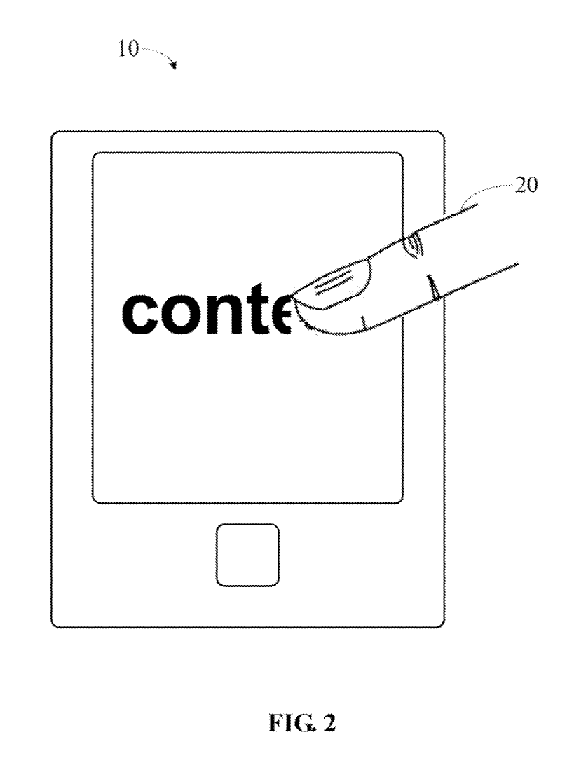

Referring to FIGS. 1 and 2, an apparatus 10 capable of erasing content displayed on a touch screen is provided. The apparatus 10 includes a touch display unit 11, a control unit 12, a storage unit 13, an area detecting unit 14, a time calculating unit 15, and an erasing unit 16.

The touch display unit 11 can determine touch coordinates of a touch operation performed by a user with an input apparatus 20, such as a palm or a stylus, on the touch display unit 11. In detail, during the touch operation, the touch display unit 11 determines a plurality of touch coordinates of a first touched place of the touch operation on the touch display unit 11, and determines a touch area of the first touched place accordingly. The touch display unit 11 further determines a touch trace of the touch operation on the touch display unit 11 according to the changing of touch coordinates of touch places of the touch operation on the touch display unit 11. In the embodiment, the touch display unit 11 includes a touch screen and a touch controller.

The storage unit 13 is configured for storing size of a predetermined area and period of a predetermined time. In the embodiment, the size of the predetermined area and the period of the predetermined time are preset by a user.

The area detecting unit 14 is configured for determining whether a size of the touch area of the first touched place is larger than the predetermined area size. Meanwhile, the control unit 12 activates the time calculating unit 15 to begin timing duration of the touch. When the size of the touch area of the first touched place is larger than the predetermined area size, the time calculating unit 15 continues to calculate elapsed time of the touch operation on the touch display unit 11, and deactivates the time calculating unit 15 when the elapsed time calculated by the time calculating unit 15 is equal to the predetermined time or if the touch ceases before becoming equal to the predetermined time the timer 15 is restarted to time between consecutive touches. The control unit 12 further determines whether the touch trace of the touch operation on the touch display unit 11 during timing matches other predetermined trace patterns. In the embodiment, the other predetermined trace patterns are: the touch operation is a back and forth sliding touch operation and the size of a touch area of the touch operation on the touch display unit 11 is greater than the predetermined area size. In the embodiment, the predetermined trace patterns of duration of touch, area of touch, and characteristic movement of the touch are preset by a user and changeable.

When the touch trace matches the predetermined trace patterns, the control unit 12 generates an erasing signal. The erasing unit 16 erases the content displayed within the touched area of the touch display unit 11 in response to the erasing signal.

When the touch trace does not match the predetermined trace pattern, the control unit 12 restarts the time calculating unit 15 to calculate an elapsed time from the end of the touch operation to the start of a next touch operation of the input apparatus 20 on the touch display unit 11, and determines the touch operations of the input apparatus 20 is to input content or commands other than the command to erase content, if the elapsed time is more than a predetermined time interval. In the embodiment, the predetermined time interval is equal to the predetermine time period stored in the storage unit 13. The control unit 12 executes the input commands or controls the touch display unit 11 to display the input content.

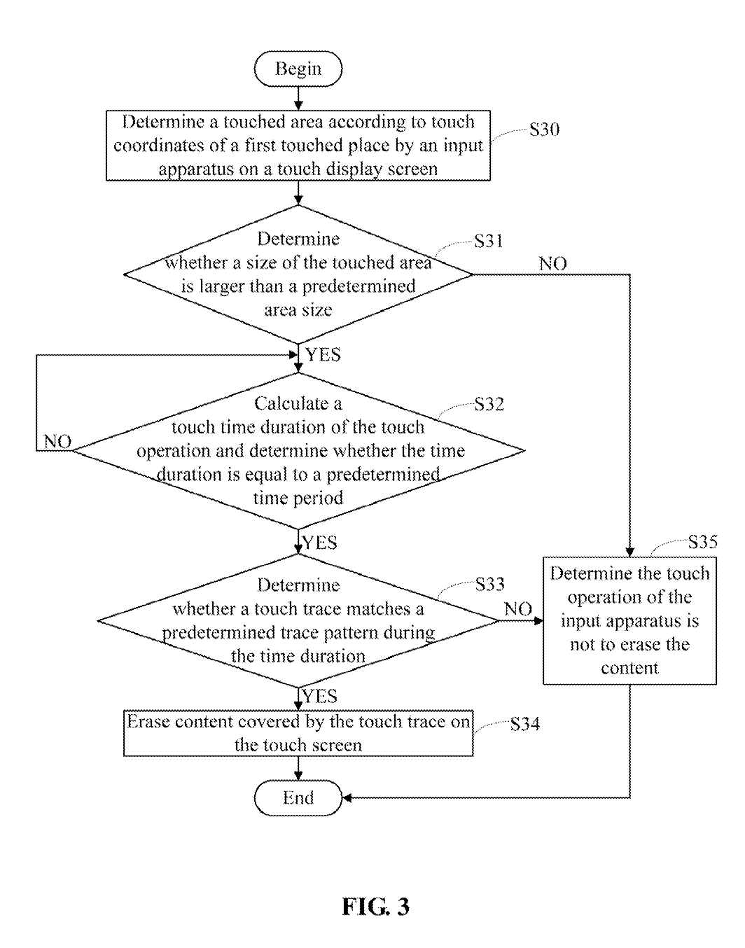

Referring to FIG. 3, a method capable of erasing content displayed on a touch screen is provided.

In step S30, the touch display unit 11 determines a plurality of touch coordinates of a first touched place of the touch operation on the touch display unit 11, and determines the touch area of the first touched place accordingly.

In step S31, the area detecting unit 14 determines whether a size of the touch area of the first touched place is larger than the predetermined area size. If yes, the procedure goes to step S32, otherwise, the procedure goes to step S35.

In step S32, the control unit 12 activates the time calculating unit 15 to calculate elapsed time of the touch operation on the touch display unit 11, and determines whether the elapsed time calculated by the time calculating unit 15 is equal to the predetermined time. If yes, the procedure goes to step S33, otherwise, the procedure returns back to step S32.

In step S33, the control unit 12 determines whether the touch trace of the touch operation on the touch display unit 11 during timing matches the predetermined trace pattern. If yes, the procedure goes to step S34, otherwise, the procedure goes to step S35.

In the embodiment, the predetermined trace pattern is: the touch operation is a move back and forth operation and the size of a touch area of the touch operation on the touch display unit 11 is always larger than the predetermined area size. In the embodiment, the predetermined trace pattern is preset by a user and changeable.

In step S34, the control unit 12 deactivates the time calculating unit 15 when the time elapse time calculated by the time calculating unit 15 is equal to the predetermined time, and generates the erasing signal. The erasing unit 16 erases the content displayed on the touch area of the touch display unit 11 in response to the erasing signal.

In step S35, the control unit 12 determines the touch operations of the input apparatus 20 is to input contents or commands excepting the command to erase content when the elapsed time is larger than a predetermined time interval, and executes the input commands or controls the touch display unit 11 to display the input contents.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus capable of erasing content comprising:
a touch display unit configured for determining touch coordinates of a first touched place of a touch operation applied by an input apparatus on the touch display unit, determining a touched area of the first touched place, and further configured for determining a touch trace according to changes of the touch coordinates;
a time calculating unit;
a storage unit configured for storing a predetermined area size and a predetermined time period;
an area detecting unit configured for determining whether a size of the touched area is larger than the predetermined area size;
a control unit configured for activating the time calculating unit to calculate a time duration of the touch operation if the size of the touched area is larger than the predetermined area size, deactivating the time calculating unit to calculate the time duration when the time duration is equal to the predetermined time period, determining whether the touch trace matches a predetermined trace pattern during the time duration, and further configured for generating an erasing signal if the touch trace matches the predetermined trace pattern; and
an erasing unit configured for erasing content covered by the touch trace on the touch display unit in response to the erasing signal.

2. The apparatus capable of erasing content as claimed in claim 1, wherein the input apparatus is a palm of a user.

3. The apparatus capable of erasing content as claimed in claim 1, wherein the predetermined trace pattern is a moving back and forth gesture and the size of the touched area of the touch operation on the touch display unit is larger than the predetermined area size.

4. The apparatus capable of erasing content as claimed in claim 3, wherein if the touch trace does not match the predetermined trace pattern, the control unit is further configured for activating the time calculating time to calculate an elapsed time between the touch operation and a next touch operation of the input apparatus on the touch display unit, and determining the next touch operation is not to erase the content if the elapsed time is larger than a predetermined time interval.

5. The apparatus capable of erasing content as claimed in claim 4, wherein the predetermined time interval is equal to the predetermined time period stored in the storage unit.

6. A method capable of erasing content display on a touch screen comprising:
determining touch coordinates of a first touched place of a touch operation applied by an input apparatus on the touch screen, and determining a touched area of the first touched place;
determining whether a size of the touched area is larger than a predetermined area size;
calculating a touch time duration of the touch operation if the size of the touched area is larger than the predetermined area size, and determining whether the touch time duration is equal to a predetermined time period;
determining whether the touch trace matches a predetermined trace pattern during the touch time duration when the touch time duration is equal to the predetermined time period; and
generating an erasing signal if the touch trace matches the predetermined trace pattern and erasing content covered by the touch trace on the touch screen in response to the erasing signal.

7. The method as claimed in claim 6, further comprising:
determining the touch operation of the input apparatus is not to erase the content if the touch trace does not match the predetermined trace pattern.

8. The method as claimed in claim 6, wherein the predetermined trace pattern is a moving back and forth gesture and the size of a touched area of the touch operation on the display screen is always larger than the predetermined area size.

9. The method as claimed in claim 6, wherein the predetermined area size is preset by a user.
